(19) United States
(12) Patent Application Publication
(10) Pub. No.: US 2011/0221906 A1
(43) Pub. Date: Sep. 15, 2011

(54) Multiple Camera System for Automated Surface Distress Measurement

(75) Inventors: Bugao Xu, Austin, TX (US); Xun Yao, Austin, TX (US); Ming Yao, Austin, TX (US)

(73) Assignee: Board of Regents, The University of Texas System, Austin, TX (US)

(21) Appl. No.: 13/046,407

(22) Filed: Mar. 11, 2011

Related U.S. Application Data
(60) Provisional application No. 61/313,453, filed on Mar. 12, 2010.

(51) Int. Cl. H04N 7/18

(52) U.S. Cl. 348/148; 348/E07.085

(57) ABSTRACT

The present invention provides a system for imaging a surface in real time. The system includes two or more real time digital imaging devices positioned to capture two or more images of a surface, wherein the two or more real time digital imaging devices are set in different exposure modes; and an image processing device that processes the two or more images, wherein the two or more images are complementary and together form a complete shadow-free image of the surface. The two or more real time digital imaging devices are line-scan cameras or other types of digital cameras, wherein each of the two or more real time digital imaging devices is independently set at an under-exposure mode, an over-exposure mode or an intermediate exposure mode. Multi-exposed images are fused together through a multi-scale decomposition and reconstruction method for crack detection.

### CROSS-REFERENCE TO RELATED APPLICATIONS

This application claims priority to U.S. Provisional application Ser. No. 61/313,453, filed Mar. 12, 2010, the contents of which is incorporated by reference herein in its entirety.

### TECHNICAL FIELD OF THE INVENTION

The present invention relates generally to a surface distress measurement system, method and apparatus, and in particular, to a surface distress detection system to detect cracks in pavement using digital imaging to obtain and store data of the pavement crack automatically.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with the type, severity and extent of surface distress for assessing the pavement conditions. Cracking is the most common distress which undermines pavement's integrity and long-term performance. Intelligent pavement maintenance decisions rely on regular and reliable inspection of cracking and other forms of distress. From early 1970's, researchers have striven to develop various automated pavement distress survey (APDS) systems to replace visual rating methods in order to reduce traffic disturbance, survey cost and risk to human inspectors, and to provide more objective and prompt results for rehabilitation management [1-7]. Most APDS systems have one or more cameras installed on a moving vehicle to capture dynamic pavement images, and then extract cracks (as narrow as 1 mm) from the images in either a real-time or an offline process. Given the complexity of pavement textures and lighting conditions, implementing such a system presents many challenges. By now, no APDS system has been truly able to perform real-time, highway-speed, full-lane, and whole-distance surveys with repeatable and accurate data.

Generally, APDS systems differ in their image acquisition devices. These devices include video, area-scan, and line-scan cameras. Recent advancements in CCD and CMOS sensor technology dramatically increases camera's resolution, sensitivity, and frame/line rate, making line-scan cameras particularly suitable for pavement inspection. A line-scan camera with 2 or 4 k pixels, a GigE interface and a line rate up to 36 kHz has greatly enabled the system to meet the need for fast, reliable, high-resolution image acquisition [8].

APDS systems also differ in their lighting approaches. In the earlier stage, some systems were designed to use natural light for its simplicity and on-vehicle energy conservation. Obviously, shadows of vehicles and roadside objects in an image could cause many problems in crack detection. As a result, current APDS systems require special lighting devices to illuminate pavements to prevent shadows from the image and to maintain consistent imaging conditions.

To work with a line-scan camera, a lighting device normally needs to cast a transverse beam to overlay the camera line that usually covers one full lane (12 ft wide). Halogen or florescent lamps, LED arrays, and laser line projectors are three common light sources used in APDS systems. Halogen or florescent lamps generate white lights which can only alleviate shadows to a limited extent because a camera filter can be used to block the sunlight. Light assemblies with multiple halogen or florescent lamps also require devoted power generators to be installed on the vehicle due to high power consumption. The dimensions of the assemblies are often wider than the vehicle body, thus increasing collision risks particularly in urban areas.

### SUMMARY OF THE INVENTION

The present invention provides a system for imaging a surface in real time. The system includes two or more real time digital imaging devices positioned to capture one or more images of a surface, wherein the two or more real time digital imaging devices are set in different exposure modes; and an image processing device that processes the one or more images to image the surface, wherein the one or more images are complementary and together form a complete shadow-free image of the surface. The two or more real time digital imaging devices are line-scan cameras, wherein each of the two or more real time digital imaging devices is independently set at an under-exposure mode, an over-exposure mode or an intermediate exposure mode.

The present invention provides a surface distress measurement apparatus for determining surface conditions having two or more real time digital imaging devices positioned to capture one or more images of a surface, wherein the two or more real time digital imaging devices are set in different exposure modes. The two or more real time digital imaging devices are independently set at an under-exposure mode, an over-exposure mode or an intermediate exposure mode.

The present invention provides a method of measuring the condition of a surface measurement by acquiring one or more images of the surface from two or more real time digital imaging devices positioned to capture one or more images of a surface, wherein the two or more real time digital imaging devices are set in different exposure modes, wherein the one or more images are complementary and compensate each other; and processing the image in real time to identify defects in the surface, wherein the processing comprises determining the intensity of one or more regions of the one or more images, comparing the intensity of one of the one or more regions to the intensity of another of the one or more regions, and designating the region as defective.

### BRIEF DESCRIPTION OF THE DRAWINGS

For a more complete understanding of the features and advantages of the present invention, reference is now made to the detailed description of the invention along with the accompanying figures and in which:

FIG. 1 is an image of the schematic design of the complementary imaging system.

FIGS. 2A and 2B are compensatory image pairs and the histograms of regions of interest, where FIG. 2A is an image taken with a vehicle shadowed and FIG. 2B is an image taken with a tree shadowed).

FIG. 3 is an image of the flow chart of image fusion.

FIG. 4 is an image of a weight map and its Gaussian pyramid.

FIG. 5 and FIG. 6 are images that show the contrast pyramids of the two tree-shadowed images.

FIG. 7 is an image that shows the fused contrast pyramid.

FIG. 8 is an image reconstructed from modified fusion pyramid.

FIG. 9A is an image for detected cracks in vehicle shadowed images and

FIG. 9B is an image for detected cracks in tree shadowed images.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Recently, laser line projection has become a dominant means for line-scan cameras in APDS systems because of its high efficiency and compact size. A laser projector is an off-the-shelf product that is easy to install and maintain. It can cut down the on-vehicle energy consumption from several kilowatts in incandescent lighting or several hundred watts in LED lighting to around 70 watts. It is also easy to provide adequate cooling through the vehicle air-conditioning system to the laser projector so that it can function reliably at anytime.

However, beam of the high power infrared lasers (class III or class IV) is potentially hazardous to the unprotected human eyes. This is especially true when the survey is conducted in urban areas. Many states mandate that the user must implement strict safety measures in order to get an operation license. The non-uniform power distribution across the lane always causes longitudinal streaks in the images generated by a line-scan camera. The narrow beam (<5 mm) of the laser line can frequently miss the alignment with the camera line when the vehicle undergoes severe vibrations, yielding horizontal dark ripples in the image. Streaks and ripples are often difficult to remove and are the major sources of false detections of cracks.

The present invention provides a safe, reliable and cost-effective APDS system for cracking inspection is still highly desirable for maintaining long-term performance of the U.S. highway network. The proposed research intends to find a better solution to the problems arising from artificial lighting by introducing a novel crack-sensing approach and associated image processing algorithms to the APDS system.

The present invention provides a novel pavement imaging method using dual line-scan cameras, and design a new APDS system that can conduct pavement inspection to determine the extent and severity of cracking for both asphalt and concrete pavements at highway speed and in any no-precipitation climate. In order to avoid problems with safety, misalignment, stability, and on-vehicle energy consumption, the new system does not use any artificial lighting. Instead, the present invention uses two cameras and natural light to capture paired images which can complement each other to form clear, shadow-free pavement images.

Design and construct a dual line-scan camera system on a survey vehicle that can output synchronized pairs of pavement images with complementary details at highway speed. The cameras are being controlled in a way to make pavements in both sunlight and shadows visible in two separate images.

The present invention provides new image registration methods that can match geometric positions of the paired images. Develop a customized image fusion algorithm using the multi-scale decomposition scheme to create a shadow-free image out of the paired images. Create effective seed-tracing algorithms that can detect and verify cracks of various pavements, estimate cracking severity levels, and classify them according to industrial standards.

The new APDS system of the present invention provides will not only eliminate the need for special artificial lighting that is potentially harmful to the unprotected people, but will also substantially reduce installation and maintenance costs and the consumption of on-vehicle energy. The system can permit a survey vehicle to drive in normal traffic, decreasing disturbance to the public as well as road hazards to human inspectors during the survey. It will also expedite data collection with high-speed imaging capacity, and improve the objectivity and accuracy of the survey data with high-quality images and enhanced image-processing algorithms.

The basic ideas of this complementary imaging method are to use two line-scan cameras to scan the same pavement surface simultaneously with different exposure settings, and to generate two distinct images which can compensate each other. One camera is set in an over-exposure mode to ensure only the image of shadowed regions will be clear and sharp, while the second camera is set in an under-exposure mode to be responsible solely for acquiring clear images of sunlit regions. The clear regions of the two images are complementary; together, they can form a complete, shadow-free picture of pavement if they are registered and synthesized properly. The cameras' exposure settings can be adjusted dynamically according to lighting situations, pavement conditions, and vehicle speeds, thus keeping visible regions in the two images always at appropriate brightness and contrast levels. When there are no shadows in the images, the exposures of the cameras are adjusted to a level at which both images are visible and can reinforce each other in crack detection. The large adjustment range of the exposure time and gain of the selected camera permits the system to work on any sunny or cloudy day. Since pavement survey is recommended to be conducted only in daytime (because ride-view imaging and other inspection instruments require daylight), nighttime operation is not a real problem with this APDS system.

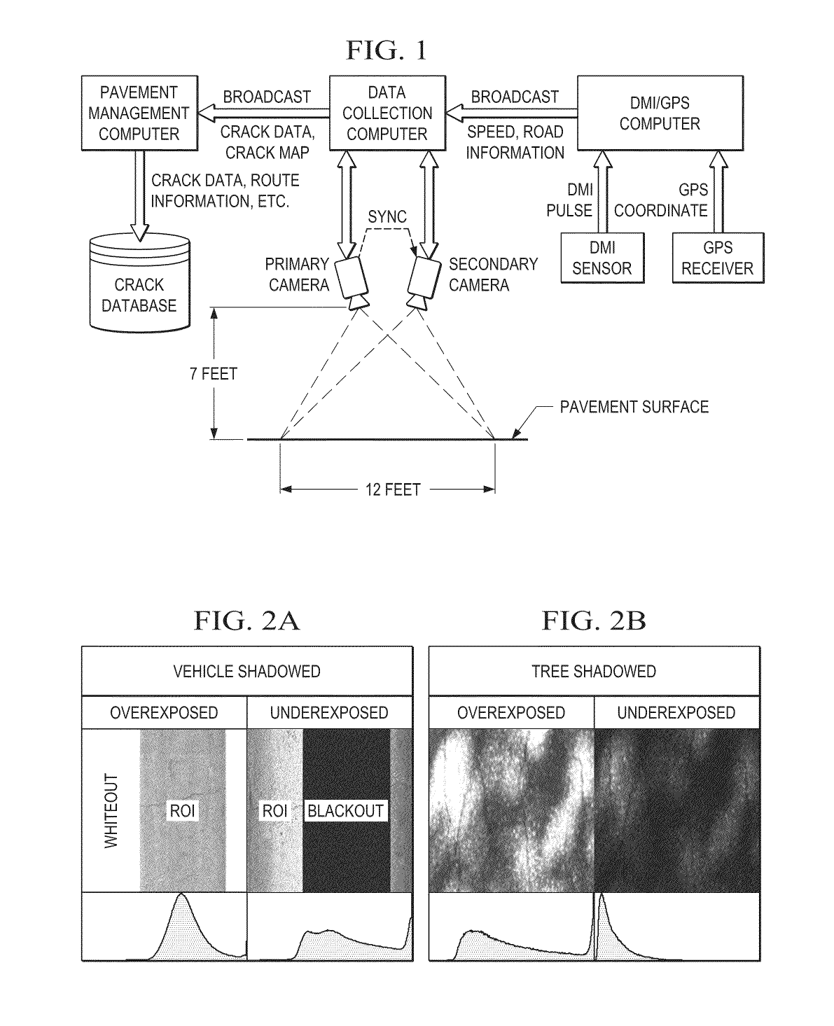

One embodiment of the present invention includes two 4 k line-scan cameras, which are placed side by side at a height of 7 feet from the ground to cover a 12-foot lane. However, the present invention may use 2, 3, 4, 5, 6, or more cameras that may be 2 k, 3 k, 4 k, 5 k, 6 k, 7 k, 8 k, 9 k, 10 k or more line-scan cameras. In addition, the cameras may be placed side by side or at unequal positions. Furthermore the distance from the ground may range from 2 feet to 15 feet depending on the particular application, e.g., 2.6 ft, 5.8 ft, 6.7 ft, 7.1 ft, 8.4 ft, 9.3 ft, etc. FIG. 1 is an image of the schematic design of the complementary imaging system. In one embodiment, the camera's resolution is 2048 pixel/line, giving a spatial resolution of 1.78 mm/pixel at this height; however other camera resolutions may be used. The cameras are synchronized by the same triggering pulse, but are set with different exposure times to target sunlit and shadowed regions, respectively. The system also needs a distance measurement instrument (DMI) and a GPS receiver to generate traveling distance, speed, and GPS coordinates. This information is broadcast to a data collection computer through a DMI/GPS computer in order to create a tag for each image and to make crack data traceable. The traveling speed is also required for calculating the instant line rate of the cameras to ensure a constant interval between two successive scan lines. The two cameras are connected to the data collection computer through GigE ports or camlink interface cards. No expensive image processing cards are needed. The two cameras are wired in series via the 15-pin GPIO connectors for synchronization. Only one camera receives the line rate (trigger pulse) from the computer. This camera is called the primary camera, and the other is the secondary camera. The two cameras start/stop scanning simultaneously and use the same scan rate. The trigger mode of both cameras is configured as “External Sync,” which means only the pulse received through the GPIO pin can trigger the camera to capture a line. Once the primary camera receives the new pulse frequency from the computer, its internal pulse generator sends corresponding pulses to the ExSync pins on the two GPIO ports. The pulse frequency is calculated depending on the instant vehicle speed and the pixel resolution.

The primary camera is purposely configured in an overexposed mode. It is designated to see clear details of shadowed regions, and it lets sunlit regions become whiteout in the image. On the other hand, the secondary camera is configured to be underexposed to make pavement details in the sunlit regions visible, letting the shadows blackout. The key to the success of creating pairs of complementary images lies in the dynamic adjustment of the overexposure and underexposure time for the cameras. In addition to the use of pairs of cameras with different exposures the present invention may use multiple cameras with multiple exposures. For example, numerous cameras set to exposures between overexposure and underexposure may be used to generate the image.

The exposure adjustments for the two next frames of images are based on the evaluation of the histograms of the current images. The histogram of a well-balanced image should cover a wide range of grayscales from black to white. In our system, only the visible regions in the pictures are the regions of interest (ROI). As a result, pixels in whiteout or blackout, are excluded from computing the histograms. To make a decision whether the grayscale of the ROI is well balanced, we need to evaluate how far the overall brightness of the ROI deviates from the central gray level, i.e., 128. To do this, the accumulated histogram of the pixels in the ROI is calculated.

Let H={Hᵢ|i=0, . . . ,255} be the histogram. Hᵢ is the percentage of pixels at gray level i. The accumulated histogram is A={Aᵢ|i=0, . . . ,255}, where A₀=H₀, and Aᵢ=Aᵢ₋₁+Hᵢ(i>0). Aᵢ is the percentage of the total pixels whose grayscales are lower than i. Assume α is a cutoff ratio on the accumulated histogram, and C_{α}is the gray scale where the accumulated histogram value is equal to α. We can assess the overall brightness G₀ of the image by using the following equation:

G₀=0.5×(C_{0.5}+0.5×(C_{0.3}+C_{0.7})). (1)

If the histogram is near to a normal distribution, G₀ will be close to C_{0.05}. In a non-normal distribution case, averaging C_{0.3} and C_{0.7} along with C_{0.5} can lead to a more reasonable G₀. After the exposure is adjusted by using the difference between G₀ and the central grayscale (i.e., 128), the overall brightness of the coming image will be brought to the central level, giving the largest room for preventing the ROI from being saturated or blackout. FIG. 2A is a compensatory image pairs and the histograms of regions of interest FIG. 2A is an image taken with a vehicle shadowed; FIG. 2B is an image taken with a tree shadowed. FIG. 2 shows two pairs of typical compensatory images captured by the two cameras in a preliminary study. The first pair (a) has a central shadow caused by the vehicle which was driven against the sunlight at time, and the second pair contains tree shadows. As designed, the overexposed (left) and underexposed (right) images made cracks in shadowed and sunlit (right) regions visible, respectively. We use the tree shadowed image as an example for explaining the image-processing algorithms in the following sections.

The entire image acquisition process is designed to be multi-threaded. Each camera owns separate threads to handle their image streams simultaneously. The DMI/GPS computer broadcasts the vehicle speed at a small time interval, e.g., every 200 ms. If the data collection computer recognizes that there is a speed change, it will convert the new speed into the corresponding line rate, and send it to the primary camera to alter the pulse frequency. This changes the scanning rate of both cameras since they are synchronized. The change of scanning rate in the cameras will take effect at the same time.

The image acquisition thread maintains a frame buffer pool which is exclusively available to its associated camera. It repeatedly checks the camera status to see whether a frame, a given number of scan lines, is finished. When it is done, the acquisition thread copies the frame into a buffer at the end of the pool, creating a job queue for image saving. When the number of queued frames in the pool reaches a predefined limit, the thread will initiate the image saving thread to dump the queued images to the hard disk at once.

The saving thread runs in parallel to the acquisition thread. Therefore, saving images will not interrupt the image acquisition, allowing the camera to scan the pavement without skipping. Therefore, consecutive images can be stitched seamlessly. Queuing images in a pool reduces the frequency of accessing the hard disk, thus saving time for the camera to operate at high scan rates. The system will be able to scan and save real-time pavement images at traveling speeds up to 112 km/h (70 mph) without skipping.

Image registration is a process to match the geometrical positions of two or more images of the same scene so that they can be overlaid in image fusion without creating artifacts in the merged image. Due to the differences in cameras' viewpoints and settings, the orientations, dimensions, and brightness of objects in separate images can be vastly different. The currently used image registration methods take advantage of the positions of common areas or common features to register multiple images.

Image fusion is a process of combining information from two or more images into a single composite image that is more informative for visual perception or computer processing. To deal with the problem, in recent years the multi-scale decomposition and reconstruction method has been employed to merge the multi-exposure images. In this fusion scheme, the source images are transformed with multi-scale decomposition (MSD) method, merging images are guided by a special feature measurement at each individual scale level. Then, the composite image is reconstructed by an inverse procedure. This framework involves different MSD methods and feature measurements, different application may combine them to yield different performance. The most commonly used MSD methods for image fusion included Laplacian, contrast, gradient pyramid transform and wavelet transform. The contrast, gradient, saturation, entropy or edge intensity is used to determine the weight map at different scale levels.

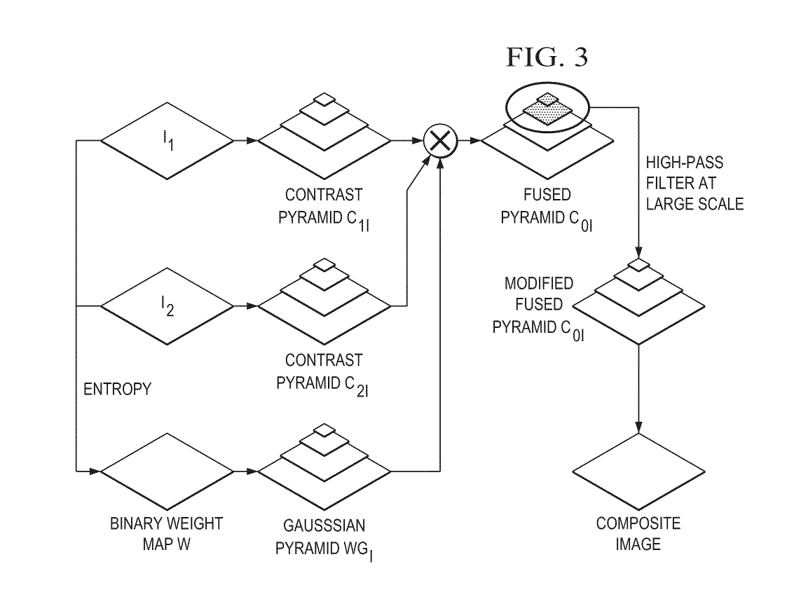

The present invention needs to merge one partially-overexposed image with one partially-underexposed image to create a composite image in which all areas appear well-exposed. Meanwhile, the discontinuity between the sunlit and shadow regions will be eliminated. FIG. 3 is an image of the flow chart of image fusion. FIG. 3 outlines the steps to implement the requirement for our application. The two source images are denoted as I₁ and I₂ respectively. Build the binary weight map W using pixel-based entropy. Build Gaussian pyramid WG₁ for W. Build contrast pyramids C₁ₗ and C₂ₗ for I₁ and I₂ . Merge C₁ₗ and C₂ₗ at individual scale levels base on WGₗ to create fused pyramid C′₀ₗ. Apply high-pass filter at large scales of C′₀ₗ to remove shadows and get C₀ₗ . . . Reconstruct composite image using C₀ₗ.

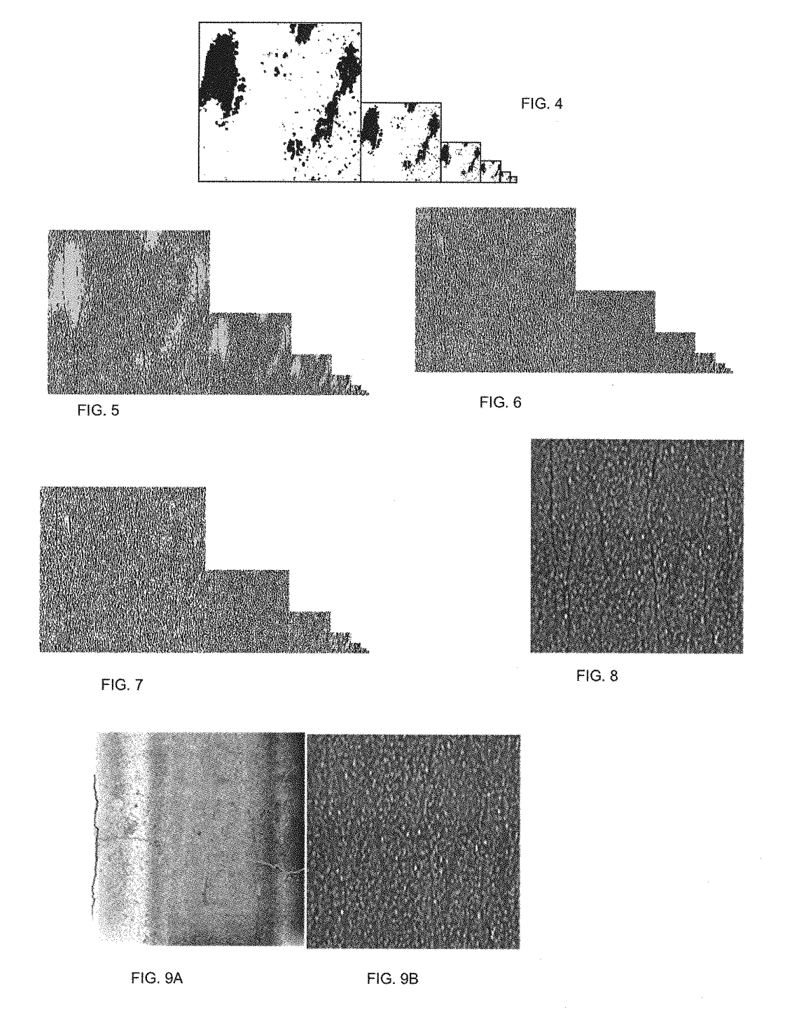

FIG. 4 is an image of a weight map and its Gaussian pyramid. The well-exposed areas need to be distinguished from overexposed or underexposed areas in each source image. Generally, an area that is overexposed or underexposed contains less texture information than a well-exposed area. Entropy is a measure of the information capacity of an area or image [50-52], and can be computed by

$${E}_{g} = {\sum }_{i = 0}^{255} - {p}_{i} log ( {p}_{i} ) ,$$

where is the probability of an arbitrary pixel that has grayscale i (i=0, 1, . . . , 255). Assume the number of pixels having grayscale i is nᵢ, and the image contains n pixels, pᵢ=nᵢ/n. When the entropy at a pixel of I₁ is larger than that of I₂, set the correspondent pixel at weight map W to be “1”, otherwise set it to be “0”. The largest image in FIG. 4 is the initial binary weight map W of the tree-shadowed image in FIG. 2.

In order to determine the fusion weights at different scale levels, the Gaussian pyramid of the weight maps W needs to be obtained. Let Gₗ be the l th level of the Gaussian pyramid for the image I. Then, G₀=I and for 1≦l≦N (N is the index of the top level of the pyramid), we have

$${G}_{l} ( i , j ) = REDUCE [ {G}_{l - 1} ] = {\sum }_{m = - 2}^{2} {\sum }_{n = - 2}^{2} w ( m , n ) {G}_{l - 1} ( 2 i + m , 2 j + n ) , \qquad ( 14 )$$

where w(m,n) is a separable weighting function, and obeys the following constraints [40]:

w(m,n)=w′(m)w′(n),w′(0)=α,w′(1)=w′(−1)=0.5 ,

and a typical value of α is 0.4. FIG. 4 Error! Reference source not found. shows the initial weight map and its Gaussian pyramid. A contrast pyramid is employed as an MSD method in this research. Let G_{l,k} the image obtained by expanding Gₗ k times. Then

G_{l, 0}=Gₗ, (15)

and for 1≦l≦N and k≧0,

$${G}_{l , k} ( i , j ) = EXPAND [ {G}_{l , k - 1} ] = 4 {\sum }_{m = - 2}^{2} {\sum }_{n = - 2}^{2} w ( m , n ) {G}_{l , k - 1} ( ( i + m ) / 2 , ( j + n ) / 2 ) , \qquad ( 16 )$$

here, only terms for which (i+m)/2 and (j+n)/2 are integers contribute to the sum. Let Cₗ be the lth contrast pyramid, we can compute C_{l as:}

Cₗ=(Gₗ−EXPAND[G_{l+1,1}])/EXPAND[G_{l+1,1}], (17)

C_{N}=G_{N} (18)

Based on the three image pyramids WGₗ,C₁ₗ,C₂₁ , the merging can be conducted on each scale level. Let Mₗ be the lth fused contrast pyramid, then,

Mₗ(i, j)=WGₗ(i, j)×C₁ₗ(i, j)+(1−WGₗ(i, j))×C₂₁(i, j) (19)

FIG. 5 and FIG. 6 show the contrast pyramids of the two tree-shadowed images. FIG. 7 shows the fused contrast pyramid. FIG. 5 is an image of the contrast pyramid of source image 1. FIG. 6 Contrast pyramid of source image 2. It is observed that shadows have much larger width dimensions (>25.4 mm) than cracks and are present only in large-scale images in the pyramid, which contain primarily low frequencies information. Hence, a high-pass filter can be applied at several top levels of the pyramid. Since finer details, such as cracks, are only present in the lower-scale images, they will not be suppressed by the filtering. We will experiment the high-pass filtering at top levels of the pyramid to determine optimal levels at which the high-pass filter should be applied.

Image reconstruction is an inverse procedure of building the pyramid. For the contrast pyramid, the procedure is:

Gₙ=Cₙ (20)

Gₗ=Cₗ·EXPAND[G_{l+1,1}]+EXPAND[G_{l+1,1}] (21)

FIG. 8 is an image reconstructed from modified fusion pyramid. The resultant composite image is shown in FIG. 8. The source images are seamless merged with the crack features being preserved and the tree shadows being repressed.

FIG. 9A is an image for detected cracks in vehicle shadowed images and FIG. 9B is an image for detected cracks in tree shadowed images. It is contemplated that any embodiment discussed in this specification can be implemented with respect to any method, kit, reagent, or composition of the invention, and vice versa. Furthermore, compositions of the invention can be used to achieve methods of the invention.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A real time surface defect imaging device comprising:
a support shaft mountable to a vehicle to extend above a surface;
a first digital imaging device with a first exposure mode positioned on the support shaft to capture a first set of images of the surface;
one or more second digital imaging devices each with a second exposure mode positioned on the support shaft to capture one or more second sets of images of the surface;
an image processing device in communication with the a first digital imaging device and each of the one or more second digital imaging devices to receive the first set of images of the surface and the one or more second sets of images of the surface and compile a complete shadow-free image of the surface to determine surface defects.

2. The system of claim 1, wherein the image processing device

3. The device of claim 1, further comprising an external illumination source to illuminate the surface to capture images of the surface at nighttime.

4. A system for imaging a surface in real time comprising:
two or more real time digital imaging devices positioned to capture two or more images of a surface, wherein the two or more real time digital imaging devices are set in different exposure modes; and
an image processing device that processes the two or more images, wherein the two or more images are complementary and together form a complete shadow-free image of the surface.

5. The system of claim 4, wherein the two or more real time digital imaging devices are line-scan cameras or other types of digital cameras.

6. The system of claim 4, wherein each of the two or more real time digital imaging devices are independently set at an under-exposure mode, an over-exposure mode or an intermediate exposure mode.

7. The system of claim 4, wherein the first line-scan camera captures an image of one or more shadowed regions of the surface.

8. The system of claim 4, wherein the second line-scan camera captures an image of one or more sunlit regions of the surface.

9. The system of claim 4, wherein the real time digital imaging device is positioned about a vehicle selected from the group consisting of a car, a truck, a van, a bus, an SUV, an ATV, a four wheeler, a trailer, a sled, a wagon, a cart, and a combination thereof

10. The system of claim 4, wherein the exposure of the line-scan cameras is adjusted dynamically according to one or more conditions selected from lighting situations, pavement conditions, vehicle speeds or a combination thereof.

11. The system of claim 4, further comprising an external illumination source to enable the devices to image pavement surface at nighttime.

12. A method of measuring the condition of a surface comprising the steps of:
acquiring two or more images of the surface from two or more real time digital imaging devices positioned to capture one or more images of a surface, wherein the two or more real time digital imaging devices are set in different exposure modes, wherein the one or more images are complementary and compensate each other; and processing the image to identify defects in the surface, wherein the processing comprises determining the intensity of one or more regions of the one or more images, comparing the intensity of one of the one or more regions to the intensity of another of the one or more regions, and designating the region as defective.

13. The method of claim 12, further comprise a multi-scale decomposition and reconstruction (MSDR) method to merge multi-exposure images into one surface image.

14. The method of claim 12, further comprise a multi-scale decomposition and reconstruction (MSDR) method for image fusion includes Laplacian pyramid transform and wavelet transform.
